(19) United States
(12) Patent Application Publication
(10) Pub. No.: US 2019/0385444 A1
(43) Pub. Date: Dec. 19, 2019

(54) VEHICLE CONTROL SYSTEM, DATA PROCESSING APPARATUS, AND VEHICLE CONTROL METHOD

(71) Applicant: Panasonic Intellectual Property Management Co., Ltd., Osaka (JP)

(72) Inventors: KAZUNORI INOUE, Tokyo (JP); TOMOAKI ABE, Kanagawa (JP); FUMIO KOSUGE, Tokyo (JP)

(21) Appl. No.: 16/554,655

(22) Filed: Aug. 29, 2019

Related U.S. Application Data
(63) Continuation of application No. PCT/JP2018/005425, filed on Feb. 16, 2018.

(30) Foreign Application Priority Data
Mar. 17, 2017 (JP) 2017-052196

(51) Int. Cl. G08G 1/01; G05D 1/00; G05D 1/02

(52) U.S. Cl. CPC G08G 1/0129; G05D 1/0276; G05D 1/0088; G08G 1/0112

(57) ABSTRACT

A vehicle control system includes a data processing apparatus and a self-driving vehicle. The data processing apparatus acquires travel history information items from a plurality of vehicles, respectively, and generates, from travel history information items, reference information in which a vector information item representing a path on which the plurality of vehicles have traveled is associated with an attribute information item relating to the path represented by the vector information item, and distributes the generated reference information to the self-driving vehicle. The self-driving vehicle executes self-driving along a path represented by the reference information acquired from data processing apparatus.

### CROSS-REFERENCE TO RELATED APPLICATIONS

This application is a continuation of the PCT International Application No. PCT/JP2018/005425 filed on Feb. 16, 2018, which claims the benefit of foreign priority of Japanese patent application No. 2017-052196 filed on Mar. 17, 2017, the contents all of which are incorporated herein by reference.

### BACKGROUND

### 1. Technical Field

The present disclosure relates to a vehicle control technology, and particularly relates to a vehicle control system that controls a vehicle based on travel history information items of vehicles, a data processing apparatus constituting the vehicle control system, and a vehicle control method for controlling a vehicle.

### 2. Description of the Related Art

A self-driving vehicle capable of autonomous traveling and unmanned traveling is being developed. A technology for generating high-precision map data including a road network for each traffic lane as data to be used by such a self-driving vehicle for self-traveling is proposed (see, for example, Japanese Patent Unexamined Publication No. 2015-4814).

### SUMMARY

Such high-precision map data are usually generated from data collected by a data collection vehicle equipped with a camera, an infrared laser scanner, and the like while traveling. However, for newly generating map data of a region of which map data have not been generated yet, or for updating map data so as to correspond to situation changes of a region of which map data have already been generated, it is necessary to allow a data collection vehicle to travel throughout the region. In order to do so, much time and labor are required. Furthermore, when the map data are managed in a state that is hierarchized into static information, quasi-static information, and dynamic information, which have different updating frequencies, update of map data and distribution of the map data to vehicles are carried out independently for each layer. Accordingly, inconsistency of the data may occur between layers.

The present disclosure provides a technology for improving data to be used for self-driving of a vehicle, and for controlling the vehicle more appropriately.

A vehicle control system of one aspect of the present disclosure includes a data processing apparatus and a self-driving vehicle. The data processing apparatus generates and distributes reference information referred to by the self-driving vehicle for executing self-driving. The self-driving vehicle executes the self-driving with reference to the reference information acquired from the data processing apparatus. The data processing apparatus includes a travel history information acquirer, a reference information generator, and a reference information distributor. The travel history information acquirer acquires travel history information items from a plurality of vehicles, respectively. The reference information generator generates the reference information from the travel history information items. The reference information distributor distributes the reference information generated by the reference information generator to the self-driving vehicle. Note here that the reference information generator associates a vector information item with an attribute information item in the reference information. The vector information item represents a path on which the plurality of vehicles have traveled. The attribute information item relates to the path represented by the vector information item. The self-driving vehicle includes a reference information acquirer that acquires the reference information from the data processing apparatus, and a controller that executes the self-driving along the path represented by the reference information.

Another aspect of the present disclosure is a data processing apparatus. This apparatus includes a travel history information acquirer, a reference information generator, and a reference information distributor. The travel history information acquirer acquires travel history information items from a plurality of vehicles, respectively. The reference information generator generates reference information from the travel history information items. The reference information is referred to by a self-driving vehicle for executing self-driving. The reference information distributor distributes the reference information to the self-driving vehicle. The reference information generator associates a vector information item with an attribute information item in the reference information. The vector information item represents a path on which a plurality of vehicles have traveled. The attribute information item relates to the path represented by the vector information item.

Still another aspect of the present disclosure is a vehicle control method. In this method, firstly, reference information referred to by a self-driving vehicle for executing self-driving is acquired from a data processing apparatus; and then the self-driving of the self-driving vehicle is executed along a path represented by the reference information. The reference information is generated from travel history information items acquired from a plurality of vehicles, respectively. Furthermore, a vector information item is associated with an attribute information item in the reference information. The vector information item represents a path on which a plurality of vehicles have traveled, and the attribute information item relates to the path represented by the vector information item.

Note here that conversions of any combinations of the above components and representation of the present disclosure among methods, apparatuses, systems, non-transient recording media, computer programs, etc. are effective as aspects of the present disclosure.

The present disclosure can control a self-driving vehicle more appropriately.

### BRIEF DESCRIPTION OF DRAWINGS

FIG. 1 is a view for illustrating reference information to be used in a vehicle control system in accordance with an exemplary embodiment of the present disclosure.

FIG. 2 is a functional block diagram showing a configuration of the vehicle control system in accordance with the exemplary embodiment of the present disclosure.

FIG. 3 shows an example of the reference information to be used in the vehicle control system shown in FIG. 2.

### DETAILED DESCRIPTION OF PREFERRED EMBODIMENTS

As described above, in a conventional self-driving technology, a vehicle is controlled with reference to high-precision map data including a road network for each traffic lane. On the contrary, the exemplary embodiment of the present disclosure fundamentally changes an idea and proposes a technology in which a vehicle is controlled based on the reference information generated from travel history information items of many vehicles. This technology does not need high-precision map data which have been essential to most of conventional self-driving technologies. Therefore, all of the above-mentioned technical problems can be solved. Furthermore, a vehicle can be self-driven so as to follow a path on which many vehicles have actually traveled. Consequently, the vehicle can be self-driven in a safer and more accurate path.

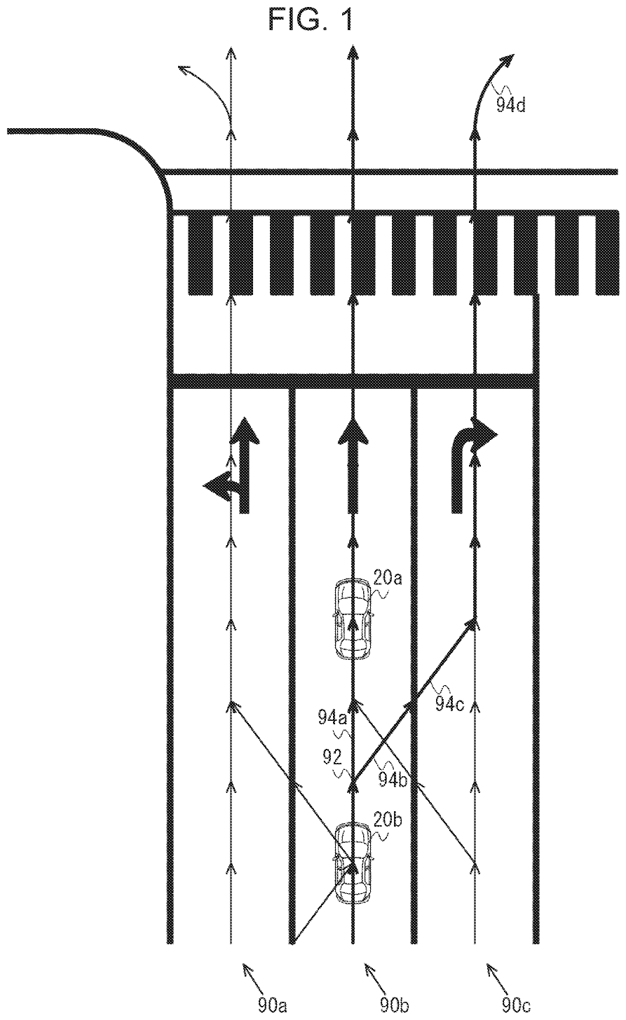

FIG. 1 is a view for illustrating reference information to be used in a vehicle control system in accordance with an exemplary embodiment of the present disclosure. The reference information includes vector information items each generated by statistical processing of travel history information items of many vehicles. Each of the vector information items represents a part of an average path on which many vehicles have actually traveled. In this exemplary embodiment, the vector information item is generated so as to have a size appropriate to control a vehicle. The size is, for example, a typical minimum rotation radius of a vehicle, from several meters to ten and several meters, specifically 1 m to 15 m, more specifically 3 m to 8 m, and still further specifically about 5 m. The vector information item is set such that an end point of one vector information item coincides with a starting point of another vector information item. That is to say, a path of a vehicle for each traffic lane is expressed by many vector information items ranging successively. Vehicles 20a and 20b automatically travel along successive vectors as if each of vehicles 20a and 20b traveled on a rail which is virtually constructed on a road.

In the example shown in FIG. 1, on a road having first lane 90a to third lane 90c, vectors 94a to 94d generated from the travel history information items of vehicles traveling on each lane are set. In front of the intersection ahead of vehicles, there are first lane 90a for a vehicle to go straight or turn left, second lane 90b for a vehicle to go straight, and third lane 90c for a vehicle to turn right. Average lane-change positions are generated from the travel history information items of many vehicles which have changed the lane to an appropriate lane according to the traveling direction in front of the intersection, and the positions are reflected on vectors 94a to 94d. That is to say, since many vehicles have started changing a lane at point 92 in order to change the lane from second lane 90b to third lane 90c, vector 94b is set. Since a path is set for vehicle 20a to travel straight in the intersection ahead of vehicle 20a, vehicle 20a travels along vector 94a on second lane 90b from point 92. Meanwhile, since a path is set for vehicle 20b to turn right at the intersection ahead of vehicle 20b, vehicle 20b changes a lane to third lane 90c along vectors 94b and 94c from point 92. Thus, in the exemplary embodiment, even without referring to map data in each lane, a vehicle can be allowed to automatically travel on an appropriate lane.

The reference information further includes attribute information items of the paths each represented by one of the vector information items. Each of the attribute information items includes, for example, the radius of curvature of the path represented by the one of the vector information items. Although only a path of the straight line can be expressed by only a vector information item, by adding an information item representing the shape of the curve as an attribute information item, a path having an arbitrary shape can be set as a path between the starting point position and the end point position. Therefore, since, for example, a curved path like vector 94d can be set at a curve or an intersection, a vehicle can be self-traveled in a more appropriate and smooth path.

The attribute information item may include at least one of information items, for example, a speed, the number of lanes, a lane position, presence or absence of a neighboring lane, presence or absence of a temporary stop position, a stop position, a degree of attention required, and the like, in addition to the radius of curvature of a path. These information items are included in probe traffic information collected using, for example, an on-board device for ETC (Electronic Toll Collection System) 2.0 or a car navigation system, or obtained by statistically processing or analyzing a huge amount of probe traffic information. Installation of roadside units that collects the probe traffic information from on-board devices for ETC 2.0 and the like has been advanced, and a social foundation for collecting data such as a position of a vehicle, a moving speed, and a moving direction is constructed. From a huge amount of thus collected data, the attribute information item can be set in each vector showing a path of about several meters to ten and several meters instead of a attribute information item in each road or in each region. Accordingly, a more precise attribute information item can be set, and vehicle can be controlled more finely.

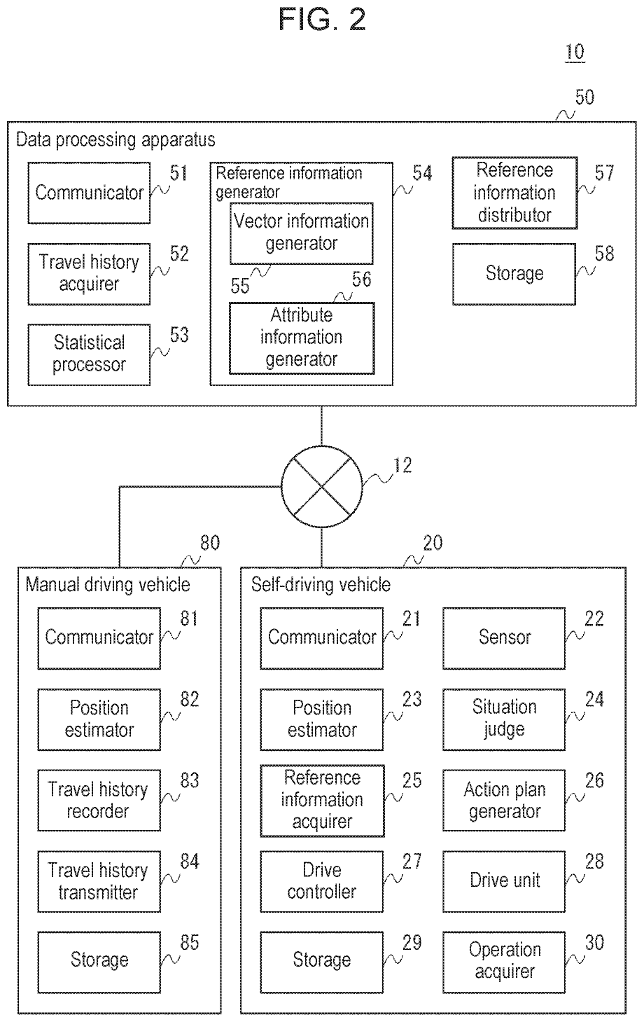

FIG. 2 shows a configuration of vehicle control system 10 in accordance with the exemplary embodiment. Vehicle control system 10 includes data processing apparatus 50, self-driving vehicle 20, manual driving vehicle 80, and network 12. Data processing apparatus 50 generates and distributes reference information referred to by self-driving vehicle 20 for executing self-driving. Self-driving vehicle 20 executes self-driving with reference to the reference information acquired from data processing apparatus 50. Manual driving vehicle 80 provides a travel history information item to be used by data processing apparatus 50 for generating the reference information. Via network 12, self-driving vehicle 20, data processing apparatus 50, and manual driving vehicle 80 communicate with each other. Note here that in order to describe a vehicle that provides the travel history information item for generating the reference information and a vehicle that self-drives with reference to the reference information, separately, they are described as “manual driving vehicle 80” and “self-driving vehicle 20”, respectively. However, it is not intended to mean that the travel history information item is acquired from only a manual driving vehicle. The travel history information item may further be acquired from self-driving vehicle 20. For example, a travel history information item when self-driving vehicle 20 is driven manually may further be acquired.

Manual driving vehicle 80 includes communicator 81, position estimator 82, travel history recorder 83, travel history transmitter 84, and storage 85. This configuration is implemented by CPU (central processor), a memory, and other LSI (large-scale integrated circuit) of an arbitrary computer as hardware, and implemented by a program loaded in a memory and the like as software. Herein, functional blocks implemented by cooperation thereof are shown. Therefore, a person skilled in the art would understand that these functional blocks can be implemented in various forms by only hardware, or by a combination of hardware and software.

Communicator 81 controls communication with the other apparatus via network 12. Position estimator 82 estimates a current position of manual driving vehicle 80 based on, for example, a signal received by GNSS (Global Navigation Satellite System(s)) receiver. Travel history recorder 83 records a travel history information item of manual driving vehicle 80 in storage 85. The travel history information item includes, for example, a position and a speed of manual driving vehicle 80, information items acquired by various sensors provided to manual driving vehicle 80. Travel history transmitter 84 transmits the travel history information item recorded by travel history recorder 83 to data processing apparatus 50 via communicator 81. Travel history transmitter 84 may transmit travel history information items regularly with a predetermined time interval, or may transmit a travel history information item when communication with respect to a roadside unit has been established.

Data processing apparatus 50 includes communicator 51, travel history acquirer 52, statistical processor 53, reference information generator 54, reference information distributor 57, and storage 58. Reference information generator 54 includes vector information generator 55 and attribute information generator 56. These configurations can also be implemented in various forms by only hardware, a combination of hardware and software.

Communicator 51 controls communication with the other apparatus via network 12. Travel history acquirer 52 acquires the travel history information item transmitted from manual driving vehicle 80, and accumulates the travel history information item in storage 58. Statistical processor 53 subjects the travel history information items accumulated in storage 58 to statistic processing regularly at a predetermined timing, for example, at a predetermined time interval. Statistical processor 53 calculates an average path by an arbitrary statistical technique from paths on which a plurality of manual driving vehicles 80 have traveled, and smoothes them so as to generate a path on which self-driving vehicle 20 can safely travel. Furthermore, statistical processor 53 calculates representative values such as an average value, a weighted average value, a median value, a cut average value, an intermediate value, a quartile point, a maximum value, a minimum value, and a most frequent value, and a statistical amount such as variance, standard deviation, skewness, a kurtosis, and a correlation coefficient.

Statistical processor 53 further analyzes attribute of a path based on the calculated statistical amount. For example, a position at which almost all vehicles stop is determined to be a position at which traffic law obliges a driver to make a temporary stop. A position at which a predetermined percentage of vehicles stop but the other vehicles pass through at a usual speed may be determined to be a position at which vehicles stop with high frequency due to waiting for a signal or traffic jam. Furthermore, as described above, the average position at which vehicles start and end changing of a lane is determined, for example, in front of an intersection. If such information is reflected on reference information, self-driving vehicle 20 that performs self-driving with reference to the reference information makes a temporary stop, or starts and ends changing a lane at almost uniform position. Accordingly, other vehicles can easily predict behavior of self-driving vehicle 20, so that vehicles can drive more safely. Furthermore, also for self-driving vehicle 20, for example, since self-driving vehicle 20 can know an average speed of vehicles traveling in a main line at the time of joining into the main line, self-driving vehicle 20 can appropriately accelerate the speed in accordance with the speed of vehicles traveling in the main line and can join into the main line safely. Furthermore, even in a case where road conditions are changed, for example, a lane is closed due to road construction, a traffic accident, or the like, when manual driving vehicle 80 appropriately travels by changing a lane or by selecting different path, the travel history item thereof is reflected on the reference information, and self-driving vehicle 20 can follow it and travel appropriately. Thus, as compared with the case of referring to high-precision map data, time and labor required to follow changes of road conditions can be reduced dramatically. Information generated by statistical processor 53 may be provided to administrative body, and the like, for reviewing traffic regulations, and the like. This can provide an opportunity to review a limiting speed and the like to a more appropriate value.

Statistical processor 53 may perform statistical processing after one or more abnormal values are deleted in advance. For example, with reference to information about occurrence status of a traffic accident or a violation of traffic regulations, a travel history information item at the occurrence of the traffic accident or the violation of traffic regulations may be deleted. Alternatively, manual driving vehicle 80 may be configured to not transmit the travel history information item to data processing apparatus 50 at the occurrence of the traffic accident or the violation of traffic regulations. Thus, the safety and reliability of the reference information generated from the travel history information items can be secured, and the vehicle can be controlled safely and appropriately according to the reference information.

Vector information generator 55 divides a traveling path generated by statistical processing by statistical processor 53 into vectors each having a predetermined size and generates vector information items. Vector information generator 55 may generate a directed graph showing a path on which self-driving vehicle 20 can travel by setting nodes at predetermined intervals on the traveling path generated by statistical processing by statistical processor 53 and generating vectors each linking adjacent two of these nodes. Vector information generator 55 may set nodes preferentially at positions at which vehicles stop or at positions at which the moving direction or the moving speed is changed. Attribute information generator 56 set, to each of the vectors generated by vector information generator 55, various information items generated by statistical processing by statistical processor 53 as an attribute information item relating to a path represented by each of the vectors. Attribute information generator 56 may include not only an information item obtained from the travel history information item of a vehicle, but also an information item relating to traffic regulations such as a limiting speed, a temporary stop position, and permission of a lane change, which are designated to a road, or an information item including irregularities on road surfaces or an information item such as an occurrence status of accidents from the outside in the attribute information item.

Reference information distributor 57 distributes the reference information generated by reference information generator 54 to self-driving vehicle 20. Reference information distributor 57 may transmit reference information of a requested region to self-driving vehicle 20 in response to a request from self-driving vehicle 20, or may automatically distribute reference information of a region to self-driving vehicle 20 existing in the region.

Self-driving vehicle 20 includes communicator 21, sensor 22, position estimator 23, situation judge 24, reference information acquirer 25, action plan generator 26, drive controller 27, drive unit 28, storage 29, and operation acquirer 30. These configurations also can be implemented in various forms by only hardware or by a combination of hardware and software.

Communicator 21 controls communication with other apparatuses via network 12. Sensor 22 is a generic name of various sensors for detecting situations outside self-driving vehicle 20 and states of self-driving vehicle 20. As sensors for detecting situations outside self-driving vehicle 20, for example, a camera, a millimeter wave radar, LIDAR (Light Detection and Ranging, Laser Imaging Detection and Ranging), a sonar, a temperature sensor, an atmospheric pressure sensor, a humidity sensor, an illumination sensor, and the like, are installed. The outside situations include situations of a road on which self-driving vehicle 20 travels, environment including weather, other vehicles existing in the vicinity of self-driving vehicle 20 (including other vehicles or the like traveling on the adjacent lane). As sensors to detect states of self-driving vehicle 20, an acceleration sensor, a gyro sensor, a geomagnetic sensor, an inclination sensor, and the like, are installed. Position estimator 82 estimates the current position of self-driving vehicle 20 based on signals that GNSS receiver receives, or the like.

Situation judge 24, based on the detected information by sensor 22, judges the situation outside self-driving vehicle 20 and the situation of self-driving vehicle 20. For example, situation judge 24 determines a distance from self-driving vehicle 20 to front (leading) vehicle and a distance from self-driving vehicle 20 to rear (following) vehicle, and speeds of the front and rear vehicles. Although static information, such as the radius of curvature of the road is reflected in the reference information, the dynamic information such as obstruction that has fallen on the road will not be reflected immediately in the reference information. Therefore, situation judge 24 appropriately judges the situation and reflects the situation on the control of the self-driving.

Reference information acquirer 25 acquires reference information from data processing apparatus 50, and stores the reference information in storage 29. Reference information acquirer 25 may automatically request reference information around a current position of self-driving vehicle 20 to data processing apparatus 50 and acquire the information from data processing apparatus 50, or may automatically request reference information between a current position of self-driving vehicle 20 and a destination or reference information around the destination to data processing apparatus 50 and acquire the information from data processing apparatus 50, or may request reference information of a region designated by a user to data processing apparatus 50 and acquire the information from data processing apparatus 50. Since reference information for a predetermined range ahead of self-driving vehicle 20 in the traveling direction is necessary for the immediate self-driving, the reference information is acquired from data processing apparatus 50 without fail.

Action plan generator 26 generates an action plan of self-driving vehicle 20 for a predetermined period based on the reference information around self-driving vehicle 20 acquired by reference information acquirer 25 and situations around self-driving vehicle 20 judged by situation judge 24. Action plan generator 26 constructs a path that can reach the destination from the current position of self-driving vehicle 20 by a plurality of vector information items, sequentially confirms the situation around self-driving vehicle 20 judged by situation judge 24, and generates control values for traveling along the respective vectors also by referring to attribute information items associated with the vector information items. When the surroundings of self-driving vehicle 20 do not require special control, action plan generator 26 allows self-driving vehicle 20 to drive at a speed included in the attribute information items. This allows self-driving vehicle 20 to travel at an average speed of actual driving of a large number of other vehicles, so that the self-driving can be executed safely at a more appropriate speed. When the surroundings of self-driving vehicle 20 require special control, action plan generator 26 generates an action plan corresponding to the situation. For example, when it is sensed that an obstruction exists in front of self-driving vehicle 20, it is determined whether or not it is possible to detour to avoid the obstruction. If possible, the steering wheel is steered to detour the obstruction. If not possible, self-driving vehicle 20 is stopped in front of the obstruction. Furthermore, when the surrounding vehicles and self-driving vehicle 20 are traveling at a speed slower than the speed included in the attribute information items, it may be determined that the road is congested, and the speed of self-driving vehicle 20 may be controlled using techniques such as Adaptive Cruise Control (ACC). In this way, action plan generator 26 calculates a control value for executing the self-driving along with the vector information items while action plan generator 26 appropriately corresponds to a surrounding situation by applying arbitrary automatic operation algorithm.

Drive unit 28 includes configurations such as a steering, a brake, and an engine for driving self-driving vehicle 20. Drive controller 27 includes a steering ECU (electronic controller), a brake ECU, and an engine ECU for controlling respective components of drive unit 28. Drive controller 27 controls drive unit 28 according to the control value generated by action plan generator 26.

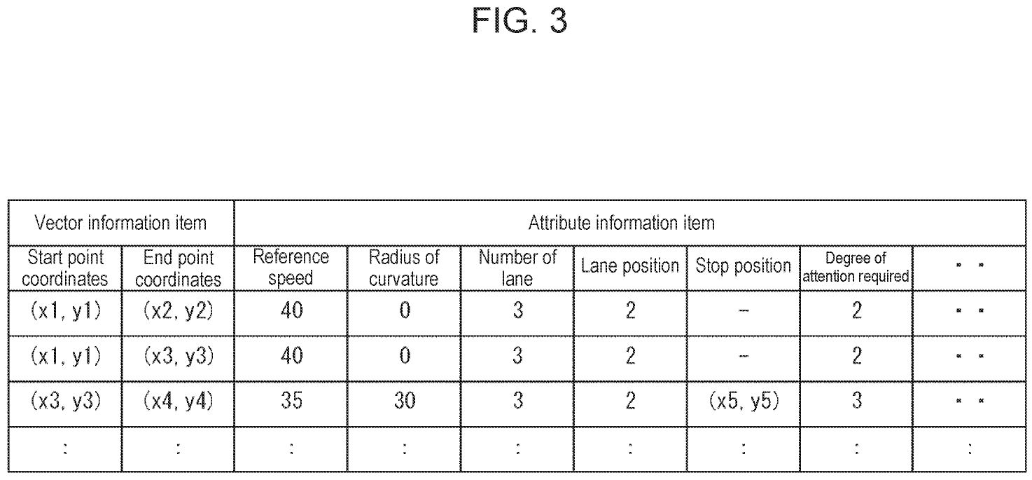

FIG. 3 shows examples of reference information to be used in the vehicle control system in accordance with the exemplary embodiment. The reference information includes vector information items and attribute information items, and both are associated with each other and stored in storage 58. The vector information items includes start point coordinates and end point coordinates. The vector information items may further include information indicating the size of the vector and the direction of the vector, but these information items may not be stored in storage 58 because these information items can be calculated from the start point coordinates and the end point coordinates. The attribute information items include information items such as a reference speed, a radius of curvature, the number of lanes, a lane position, a stop position, and a degree of attention required. These information items are generated by statistically processing and analyzing travel history information items of a large number of vehicles.

According to the exemplary embodiment of the present disclosure, a vehicle can be controlled safely and appropriately even without referring to high-precision map data. Furthermore, since the reference information is generated from history information items when vehicles actually travel, the safety and reliability of the reference information can be secured. Furthermore, the time and labor required to generate the data necessary to execute self-driving can be greatly reduced, and a data amount, a communication amount, and a processing load can also be significantly reduced. Response to change in the road conditions and terrain can be quickly carried out. Further, since a self-driving vehicle can be allowed to drive automatically in accordance with vector information items, the self-driving vehicle can be allowed to drive safely and appropriately even in a situation where it is difficult to detect a lane, such as when there is snow on a road surface or when a picture cannot be taken properly due to direct sunlight entering a camera or due to bad weather. Furthermore, since the self-driving is executed according to the high-density reference information reflecting the actual travel history, the time required to reach the destination can be predicted more accurately.

An outline of one aspect of the present disclosure is as follows. A vehicle control system of the one aspect of the present disclosure includes a data processing apparatus and a self-driving vehicle. The data processing apparatus generates and distributes reference information referred to by the self-driving vehicle for executing self-driving. The self-driving vehicle executes the self-driving with reference to the reference information acquired from the data processing apparatus. The data processing apparatus includes a travel history information acquirer, a reference information generator, and a reference information distributor. The travel history information acquirer acquires travel history information items from a plurality of vehicles, respectively. The reference information generator generates the reference information from the travel history information items. The reference information distributor distributes the reference information generated by the reference information generator to the self-driving vehicle. Note here that the reference information generator associates a vector information item representing a path on which the plurality of vehicles have traveled with an attribute information item relating to the path represented by the vector information item in the reference information. The self-driving vehicle includes reference information acquirer configured to acquire the reference information from the data processing apparatus, and a controller configured to execute the self-driving along the path represented by the reference information.

This aspect can improve data to be used for the self-driving of the vehicle, and can provide a technology for appropriately controlling the vehicle. Note here that “path on which a plurality of vehicles have traveled” may be a path on which a part or all of the plurality of vehicles actually travel, or a path statistically calculated from travel history in which a plurality of vehicles have traveled, as described above.

Another aspect of the present disclosure is a data processing apparatus. This apparatus includes a travel history information acquirer, a reference information generator, and a reference information distributor. The travel history information acquirer acquires travel history information items from a plurality of vehicles, respectively. The reference information generator generates reference information referred to by the self-driving vehicle for executing self-driving, from the travel history information items. The reference information distributor distributes the reference information to the self-driving vehicle. The reference information generator associates a vector information item representing a path on which a plurality of vehicles have traveled with an attribute information item relating to the path represented by the vector information item in the reference information.

This aspect can also improve data to be used for the self-driving of the vehicle, and can provide a technology for appropriately controlling the vehicle. Still another aspect of the present disclosure is a vehicle control method. In this control method, firstly reference information referred to by a self-driving vehicle for executing self-driving is acquired from data processing apparatus; and then the self-driving of the self-driving vehicle is executed along the path represented by this reference information. The reference information is generated from travel history information items acquired from a plurality of vehicles. Furthermore, in the reference information, a vector information item representing a path on which the plurality of vehicles have traveled and an attribute information item relating to the path represented by the vector information item are associated with each other.

Furthermore, still another aspect of the present disclosure is a non-transient recording medium which stores a control program allowing a computer to execute the above-mentioned control method.

These aspects can also improve data to be used for the self-driving of the vehicle, and can provide a technology for appropriately controlling the vehicle.

As mentioned above, description is made based on the exemplary embodiments of the present disclosure. It will be understood by a person skilled in the art that this embodiment is just an example and that various modifications of each of the components or combinations of the processes of the embodiment can be made within the scope of the claims.

According to the present disclosure, a self-driving vehicle can be controlled more appropriately. Therefore, the present disclosure is useful for a technology for controlling a self-driving vehicle.

What is claimed is:

1. A vehicle control system comprising:
a data processing apparatus; and
a self-driving vehicle,
wherein the data processing apparatus is configured to generate and distribute reference information referred to by the self-driving vehicle for executing self-driving, and the self-driving vehicle is configured to execute the self-driving with reference to the reference information acquired from the data processing apparatus,
the data processing apparatus includes:
a travel history information acquirer configured to acquire travel history information items from a plurality of vehicles, respectively;
a reference information generator configured to generate the reference information from the travel history information items; and
a reference information distributor configured to distribute the reference information generated by the reference information generator to the self-driving vehicle,
the reference information generator is further configured to associate a vector information item with an attribute information item in the reference information, the vector information item representing a path on which the plurality of vehicles have traveled, and the attribute information item relating to the path represented by the vector information item, and
the self-driving vehicle includes:
a reference information acquirer configured to acquire the reference information from the data processing apparatus, and
a controller configured to execute the self-driving along the path represented by the reference information.

2. The vehicle control system according to claim 1,
wherein the vector information item and the attribute information item are one of a plurality of sets of vector information items and attribute information items respectively associated with each other,
the reference information includes the plurality of sets of vector information items and attribute information items, and represents a plurality of paths, and
the controller configured to execute the self-driving along one of the plurality of paths.

3. A data processing apparatus comprising:
a travel history information acquirer configured to acquire travel history information items from a plurality of vehicles, respectively;
a reference information generator configured to generate reference information referred to by a self-driving vehicle for executing self-driving from the travel history information items; and
a reference information distributor configured to distribute the reference information to the self-driving vehicle,
wherein the reference information generator is further configured to associate a vector information item with an attribute information item in the reference information, the vector information item representing a path on which the plurality of vehicles have traveled, and the attribute information item relating to the path represented by the vector information item.

4. The data processing apparatus according to claim 3,
wherein the vector information item and the attribute information item are one of a plurality of sets of vector information items and attribute information items respectively associated with each other,
the reference information includes the plurality of sets of vector information items and attribute information items, and represents a plurality of paths.

5. A vehicle control method comprising:
acquiring reference information referred to by a self-driving vehicle for executing self-driving from a data processing apparatus; and
executing the self-driving of the self-driving vehicle along a path represented by the reference information,
wherein the reference information is generated from travel history information items acquired from a plurality of vehicles, respectively, and includes a vector information item and an attribute information item associated with the vector information item, the vector information item representing a path on which the plurality of vehicles have traveled, and the attribute information item relating to the path represented by the vector information item.

6. The vehicle control method according to claim 5,
wherein the vector information item and the attribute information item are one of a plurality of sets of vector information items and attribute information items respectively associated with each other,
the reference information includes the plurality of sets of vector information items and attribute information items, and represents a plurality of paths, and
the self-driving of the self-driving vehicle is executed along one of the plurality of paths.
